(19) United States
(12) Patent Application Publication
(10) Pub. No.: US 2013/0113770 A1
(43) Pub. Date: May 9, 2013

(54) DISPLAY DEVICE AND DRIVING METHOD THEREOF

(71) Applicants: Sun-Koo KANG, Seoul (KR); Young-Il BAN, Hwaseong-si (KR); Sun Kyu SON, Suwon-si (KR)

(72) Inventors: Sun-Koo KANG, Seoul (KR); Young-Il BAN, Hwaseong-si (KR); Sun Kyu SON, Suwon-si (KR)

(73) Assignee: SAMSUNG DISPLAY CO., LTD., Yongin-City (KR)

(21) Appl. No.: 13/495,434

(22) Filed: Jun. 13, 2012

(30) Foreign Application Priority Data
Nov. 4, 2011 (KR) 10-2011-0114747

(51) Int. Cl. G09G 3/36; G09G 5/00

(52) U.S. Cl. 345/209; 345/96

(57) ABSTRACT

A display device includes: a display area including a plurality of pixels, where each of the pixels includes m subpixels; and a plurality of data lines connected to the pixels, where 2n pixels of the pixels define an inversion reference group, where 2mn subpixels in the inversion reference group are applied with data voltages of a same polarity, and where each of n and m is a natural number.

This application claims priority to Korean Patent Application No. 10-2011-0114747, filed in on Nov. 4, 2011, and all the benefits accruing therefrom under U.S.C. §119, the content of which in its entirety is herein incorporated by reference.

### BACKGROUND OF THE INVENTION

(a) Field of the Invention

Exemplary embodiments of the invention relate to a display device and a driving method of the display device, a liquid crystal display, and a driving method.

(b) Description of the Related Art

A liquid crystal displays is one of the most widely used type of flat panel display. The liquid crystal display typically includes two display panels, on which field generating electrodes, e.g., pixel electrodes and a common electrode, are provided, and a liquid crystal layer that is interposed between the display panels. The liquid crystal display applies voltages to the field generating electrodes to generate an electric field in the liquid crystal layer, which in turn determines the alignment of liquid crystal molecules of the liquid crystal layer and thus the polarization of incident light, such that an image is displayed. The liquid crystal display may be inversely driven to prevent deterioration of the liquid crystal layer. In an inversion driving method, a gray is displayed using a positive voltage in some periods, and a gray is displayed using a negative voltage in other periods, and the grays with the positive and negative voltages are alternately applied such that degradation generated by rotating the liquid crystal molecules in a single direction may be effectively prevented.

However, in a dot inversion driving method, when displaying a specific pattern, the image may be seen to be green or white due to a change of the common voltage, or a specific color may be exacerbated.

### BRIEF SUMMARY OF THE INVENTION

Exemplary embodiments of the invention provide an inversion driving method and a display device using the inversion driving method such that deterioration of display quality and a greenish or a whitish hue of a display image are effectively prevented.

An exemplary embodiment of a display device includes: a display area including a plurality of pixels, where each of the pixels includes m subpixels; and a plurality of data lines connected to the pixels, where 2n pixels of the pixels define an inversion reference group, where 2mn subpixels in the inversion reference group are applied with data voltages of a same polarity, and where each of n and m is a natural number.

In an exemplary embodiment, a polarity of data voltages applied to the inversion reference group in a current frame and a polarity of data voltages applied to the inversion reference group in a next frame may be opposite to each other.

In an exemplary embodiment, m may be 3 or 4.

In an exemplary embodiment, the inversion reference group may be defined by at least one subpixel initially positioned in one pixel row of the display area and at least one subpixel positioned last.

In an exemplary embodiment, the data lines and the subpixels in the display area may have an alternating connection structure.

In an exemplary embodiment, the data lines and the subpixels may in the display area have a non-alternating connection structure.

An exemplary embodiment of a driving method of a display device includes: applying a data voltage having a first polarity to a plurality of data lines of the display device connected to 2mn subpixels of a plurality of subpixels in a display area of the display device; and applying a data voltage having a second polarity, which is opposite to the first polarity, to the data lines connected to the 2mn subpixels, where each of n and m is a natural number.

In an exemplary embodiment, the 2mn subpixels may define an inversion reference group.

In an exemplary embodiment, m may be 3 or 4.

In an exemplary embodiment, the inversion reference group may be defined by at least one subpixel initially positioned in one pixel row of the display area and at least one subpixel positioned last.

In an exemplary embodiment, the data lines and the subpixels in the display area may have an alternating connection structure.

In an exemplary embodiment, the data lines and the subpixels in the display area may have a non-alternating connection structure.

According to an exemplary embodiment, an inversion driving is performed based on an inversion reference group including 2mn subpixels, where m and n are natural numbers, such that the quality of an image is not deteriorated and the image is not greenish or whitish, and the common voltage is not swinging such that the magnitude of the current corresponding to the common voltage is substantially small, and power consumption is thereby substantially reduced.

### BRIEF DESCRIPTION OF THE DRAWINGS

The above and other features will become more apparent by describing in further detail exemplary embodiments thereof with reference to the accompanying drawings, in which:

FIG. 1 is a block diagram of an exemplary embodiment of a liquid crystal display according to the invention;

FIG. 2 is an equivalent circuit diagram showing an exemplary embodiment of one pixel of a liquid crystal display according to the invention;

FIGS. 3 and 4 are plan views of subpixels and data lines of a liquid crystal display, showing an exemplary embodiment of an inversion driving method of the liquid crystal display according to the invention;

FIGS. 5 and 6 are views showing display quality of a conventional liquid crystal display and an exemplary embodiment of a display device according the invention when displaying a first image pattern;

FIGS. 7 and 8 are views showing display quality of a conventional liquid crystal display and an exemplary embodiment of a display device according the invention when displaying a second image pattern;

FIGS. 9 and 10 are views showing changes of voltages and current of common voltage when the first image pattern is displayed by a conventional liquid crystal display and an exemplary embodiment of a display device according the invention;

FIGS. 11 and 12 are tables showing change ratio of data voltages when a display device is driven by various inversion driving methods; and

FIGS. 13 and 14 are plan views of subpixels and data lines of a liquid crystal display driven by an alternative exemplary embodiment of an inversion driving method of a liquid crystal display according to the invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

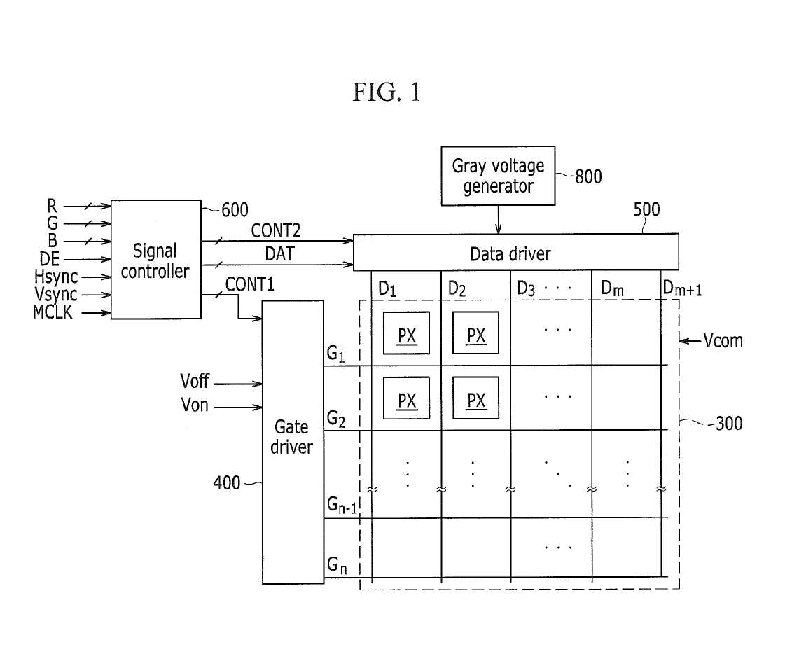

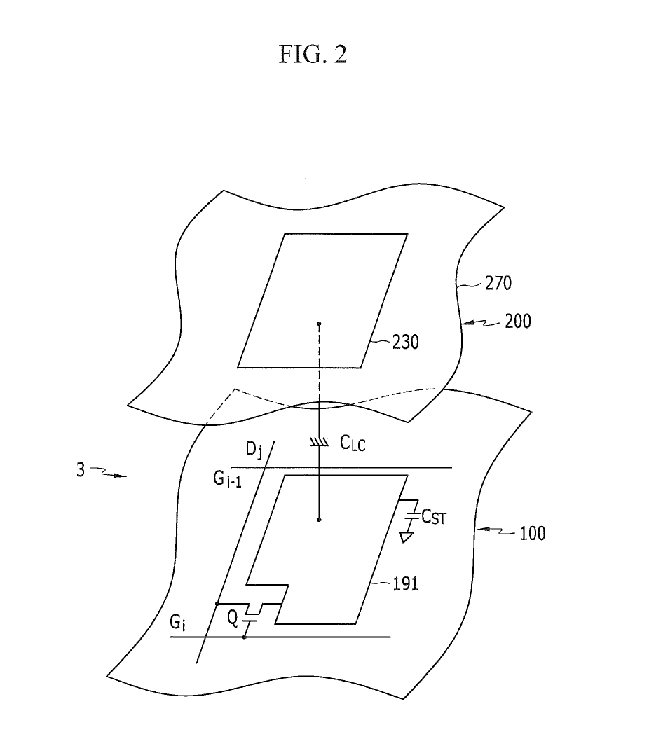

Hereinafter, an exemplary embodiment of a liquid crystal display and a driving method of the liquid crystal display will be described with reference to FIGS. 1 and 2.

FIG. 1 is a block diagram showing an exemplary embodiment of a liquid crystal display according to the invention, and FIG. 2 is an equivalent circuit diagram showing an exemplary embodiment of a pixel of a liquid crystal display according to the invention.

As shown in FIG. 1, an exemplary embodiment of a liquid crystal display includes a display area 300 of a liquid crystal panel assembly and a gate driver 400 and a data driver 500 connected to the display area 300, a gray voltage generator 800 connected to the data driver 500, and a signal controller 600, which controls the gate and data drivers 400 and 500.

In an exemplary embodiment, the display area 300 of the liquid crystal panel assembly includes a plurality of display signal lines and a plurality of pixels, which is connected to the display signal lines and arranged substantially in a matrix form. In an exemplary embodiment, the display area 300 of the liquid crystal panel assembly includes lower and upper panels 100 and 200 facing each other and a liquid crystal layer 3 interposed therebetween.

The display signal lines include a plurality of gate lines, e.g., first to n-th gate lines G1 to Gn, for transmitting gate signals (referred to as “scanning signals”) and a plurality of data lines, e.g., first to (l+1)-th data lines D1 to D(l+1), for transmitting data signals. The gate lines G1 to Gn extend substantially in a row direction and substantially parallel to each other, and the data lines D1 to D(l+1) extend substantially in a column direction and substantially parallel to each other. In such an embodiment, a number of the data lines D1 to D(l+1), e.g., l+1, is greater than a number of pixel columns, e.g., I. Here, ‘n’ and ‘l’ are natural numbers.

In an exemplary embodiment, each of the pixels, for example, a pixel PX corresponding to an i-th (i=1, 2, . . . , n) gate line Gi and a j-th (j=1, 2, . . . , l+1) data line Dj, includes a switching device Q, which is connected to the corresponding gate and data lines Gi and Dj, and a liquid crystal capacitor C_{LC} and a storage capacitor C_{ST}, which are connected to the switching device Q. In an alternative exemplary embodiment, the storage capacitor C_{ST} may be omitted.

In an exemplary embodiment, the switching element Q is a thin film transistor provided in the lower panel 100 and is a three terminal element including a control terminal connected to the corresponding gate line Gi, an input terminal connected to the corresponding data line Dj, and an output terminal connected to the liquid crystal capacitor C_{LC} and the storage capacitor C_{ST}.

The liquid crystal capacitor C_{LC} may be defined by a pixel electrode 191 of the lower panel 100 and a common electrode 270 of the upper panel 200, as two terminals, and the liquid crystal layer 3, which serves as a dielectric material and is between the two electrodes 191 and 270. The pixel electrode 191 is connected with the switching element Q, and the common electrode 270 is provided on the upper panel 200 covering substantially an entire surface of the upper panel 200, and the pixel electrode 270 receives the common voltage Vcom, as shown in FIG. 2. In an alternative exemplary embodiment, the common electrode 270 may be provided on the lower panel 100, and at least one of the two electrodes 191 and 270 may have a linear shape or a bar shape.

In an exemplary embodiment, the storage capacitor C_{ST}, which performs an auxiliary operation to assist the liquid crystal capacitor C_{LC}, is defined by an additional signal line (not shown) provided on the lower panel 100 and the pixel electrode 191 overlapping the additional signal line with an insulator interposed therebetween, and a predetermined voltage, such as the common voltage Vcom, for example, is applied to the additional signal line. In an alternative exemplary embodiment, the storage capacitor C_{ST} may be defined by the pixel electrode 191 and a previous gate line disposed overlapping the pixel electrode 191 via the insulator.

In an exemplary embodiment, the pixel PX displays one of primary colors to display a color image such that a spatial sum of the primary colors is recognized as a desired color. In an exemplary embodiment, the primary colors may be three primary color including red, green and blue colors, for example, but not being limited thereto. In an alternative exemplary embodiment, the primary colors may be four primary color including red, green, blue and white colors, for example, but not being limited thereto.

In an exemplary embodiment, as shown in FIG. 2, the pixel PX includes a color filter 230 that displays one of the primary colors on the upper panel 200 corresponding to the pixel electrode 191. In an alternative exemplary embodiment, the color filter 230 may be disposed above or below the pixel electrode 191 on the lower panel 100.

In an exemplary embodiment, at least one polarizer (not shown) for polarizing light is attached to an outer surface of the display area 300 of the liquid crystal panel assembly.

When a direction of an electric field applied to the liquid crystal layer 3 is constant in the liquid crystal display, degradation of the liquid crystal layer 3 may occur. In an exemplary embodiment, an inversion driving method, in which the data voltages of positive polarity (a positive data voltage) and negative polarity (a negative data voltage) with reference to a common voltage Vcom are alternately applied, is used.

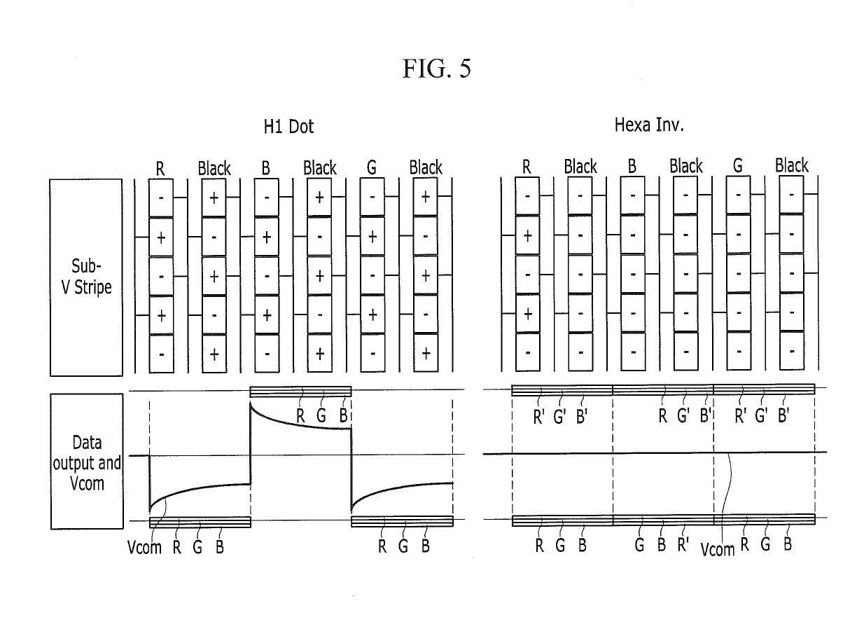

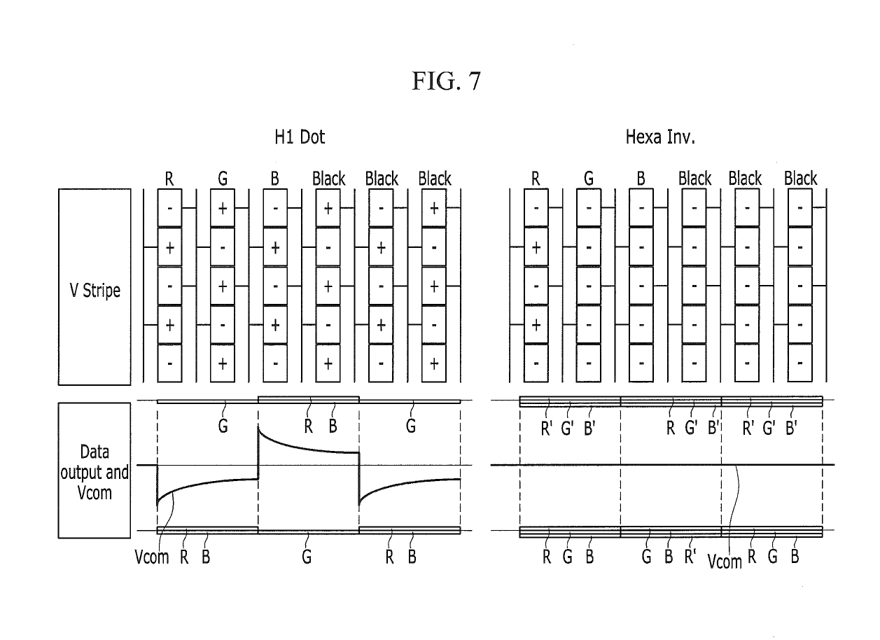

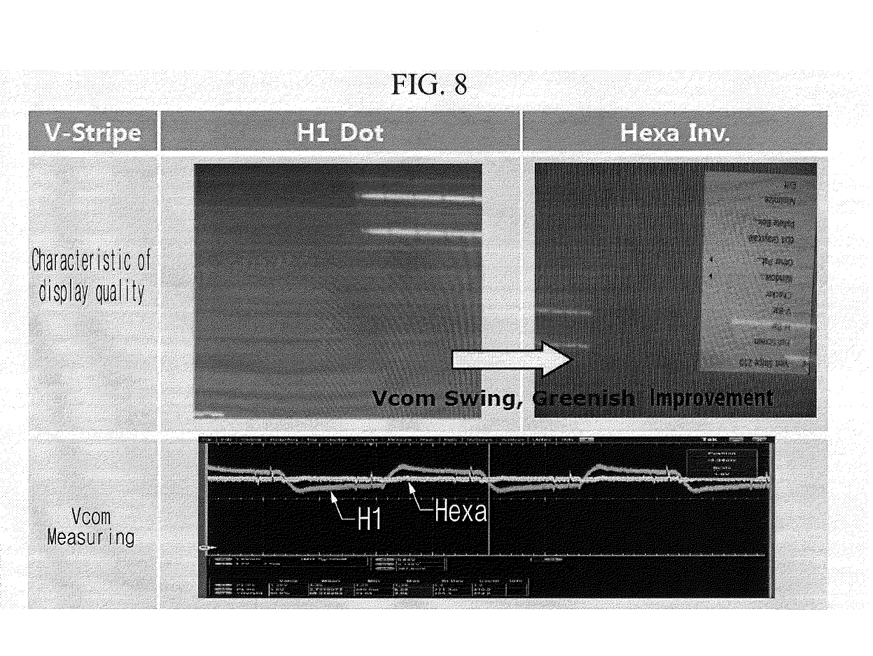

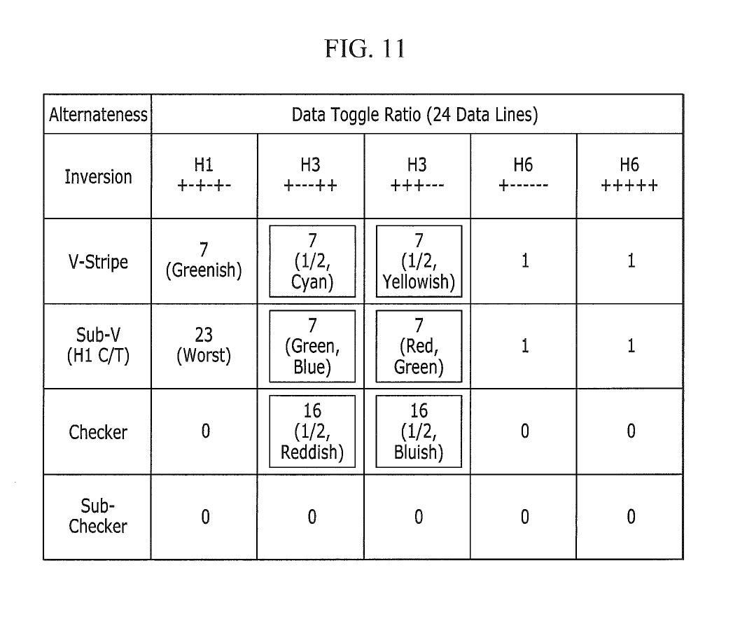

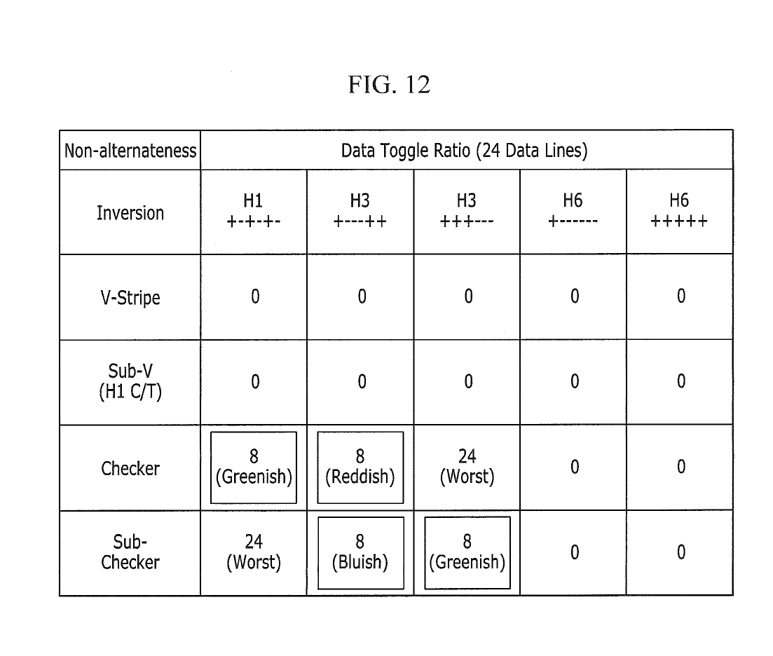

The inversion driving method may lead to deterioration of display quality when displaying a specific image pattern. FIGS. 11 and 12 show four specific image patterns including a V-stripe, a sub-V stripe, a checker and a sub-checker, and FIGS. 5, 6, 9 and 10 show an image pattern of a sub-V stripe, and FIGS. 7 and 8 show an image pattern of a V-stripe. Each of the specific image patterns will be described later in detail with reference to FIGS. 5 to 7 and FIGS. 9 to 12.

In an exemplary embodiment of the inversion driving method according to the invention, a pixel includes m subpixels, the inversion driving is performed with respect to 2mn data lines, that is, the number of data lines is 2m by n (m and n are natural numbers). In an exemplary embodiment, the pixel of a liquid crystal display has three subpixels of red, green and blue, for example, and the inversion driving is performed with respect to six data lines. In an alternative exemplary embodiment, the inversion driving is performed with respect to 12 (=6×2) data lines or 18 (=6×3) data lines, for example. Hereafter, the group including the 2mn subpixels connected to the 2mn data lines in the display area 300 will be referred to as an “inversion reference group”. In an exemplary embodiment of the inversion driving method, the inversion reference group, which is a group of the subpixels and applied with the data voltage having a same polarity, is a unit of polarity change. In an exemplary embodiment, the subpixels in a same inversion reference group may be arranged along a pixel row direction, and the polarities of two neighboring inversion reference groups in a same pixel row are opposite to each other.

In an exemplary embodiment of the inversion driving, the inversion reference group is six subpixels, which is disposed continuous in a pixel row direction, of the display area 300. In an alternative exemplary embodiment, e.g., an H6 inversion driving method of FIGS. 11 and 12, the positive data voltage is applied to a first subpixel in a pixel row of the display area 300, and the six subpixels, disposed after the first pixel and receive negative voltage, defines the inversion reference group, that is, (+)(−)(−)(−)(−)(−)(−). The polarity of the reference group may be inverted in a next frame. In such an embodiment, the last five subpixels of the pixel row and the first subpixel define the inversion reference group. In an exemplary embodiment, subpixels in an inversion reference group may be divided into two portions, positioned in a left side portion and a right side portion of the display area 300. In such an embodiment, the inversion reference group is collectively defined by at least one subpixel that is initially positioned in a pixel row of the display area and at least one subpixel that is last positioned in the pixel row. In exemplary embodiments, each of the number of the left portion and the number of the right portion may vary, and a total sum of the number of the left portion and the number of the right portion is 2mn.

In an exemplary embodiment, the polarity of each of the data lines may be inversed every horizontal period (H). In an exemplary embodiment, the inversion driving may be performed every q horizontal periods (q is a natural number). Here, n and q are natural numbers, and 2mn may be less than or equal to a number of the entire subpixel columns of the liquid crystal display (or the number of the data lines), and q may be less than or equal to the number of the entire pixel rows of the liquid crystal display (or the number of the gate lines).

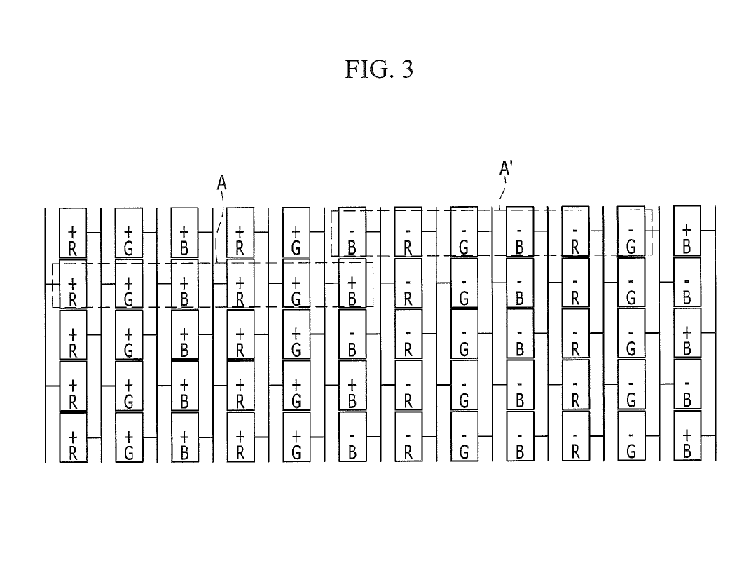

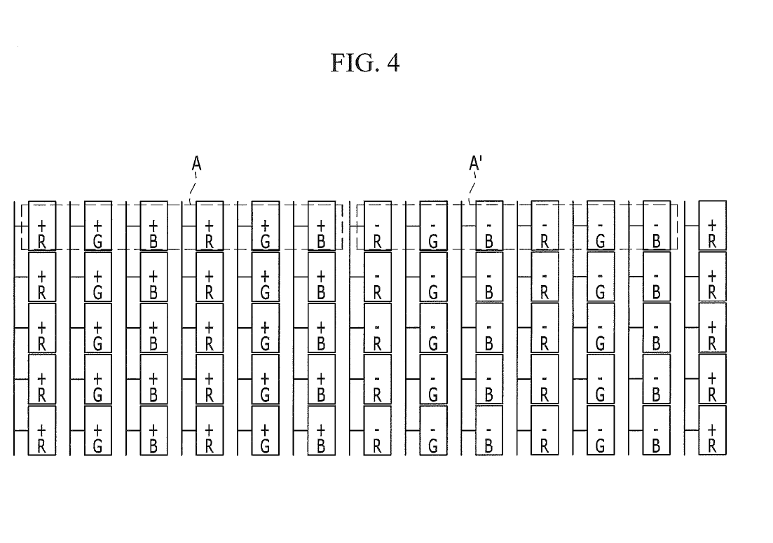

FIGS. 3 and 4 are plan views of subpixels and data lines of a liquid crystal display, showing an exemplary embodiment of an inversion driving method of the liquid crystal display according to the invention.

Hereinafter, an exemplary embodiment of the inversion driving method according to the invention will be described with reference to FIGS. 3 and 4. In such an embodiment, each of the data lines is inversely driven every horizontal period, as shown in FIGS. 3 and 4, and the number of the subpixels included in a pixel is 3 and n is 1 such that the inversion reference group includes six subpixels.

In an exemplary embodiment, as shown in FIG. 3, each of the data lines is disposed between two neighboring subpixel columns and alternately connected to the subpixels in the two neighboring subpixels in a zigzag pattern. The connection structure between the data lines and the subpixels shown in FIG. 3 is referred to as an “alternating connection structure”.

In FIG. 3, for convenience of explanation, six subpixels in an inversion reference group are indicated by A and A′. In FIG. 3, A shows the inversion reference group that receives a positive data voltage in a current frame, and A′ shows the inversion reference group that receives a negative data voltage in the current frame. In an exemplary embodiment, each of the data lines transmits a data voltage of a same polarity during one frame such that the polarity of the data voltage in a subpixel is maintained during one frame. In such an embodiment, the reference group that receives the positive data voltage in a current frame receives the negative data voltage in a next frame, and the reference group that receives the negative data voltage in a current frame receives the positive data voltage in the next frame.

In an exemplary embodiment, as in FIG. 3, where the subpixels and the data lines have the alternating connection structure, the A subpixel group in a pixel row and the A′ subpixel group in a previous pixel row have a structure, in which one subpixel of the A subpixel group and one subpixel of the A′ subpixel group overlap each other. In such an embodiment, as shown in FIG. 3, the leftmost blue (B) subpixel of the A′ subpixel group and the rightmost blue (B) subpixel of the A subpixel group are positioned in a same subpixel column.

In an alternative exemplary embodiment, as shown in FIG. 4, the data lines and the subpixels may have a structure, in which each of the data lines is connected to the subpixels in one subpixel column of the two neighboring subpixel columns. The connection structure between the data lines and the subpixels shown in FIG. 4 is referred as a “non-alternating connection structure”.

In an exemplary embodiment where the data lines and subpixels are in the non-alternating connection structure, the A subpixel group and the A′ subpixel group do not overlap each other, and are divided with respect to a data line.

Hereinafter, when the alternating connection structure is included as shown in the exemplary embodiment of FIG. 3, and six subpixels are inverted as the inversion reference group, an occurrence of a distortion of the common voltage will be described with reference to FIGS. 5 to 8.

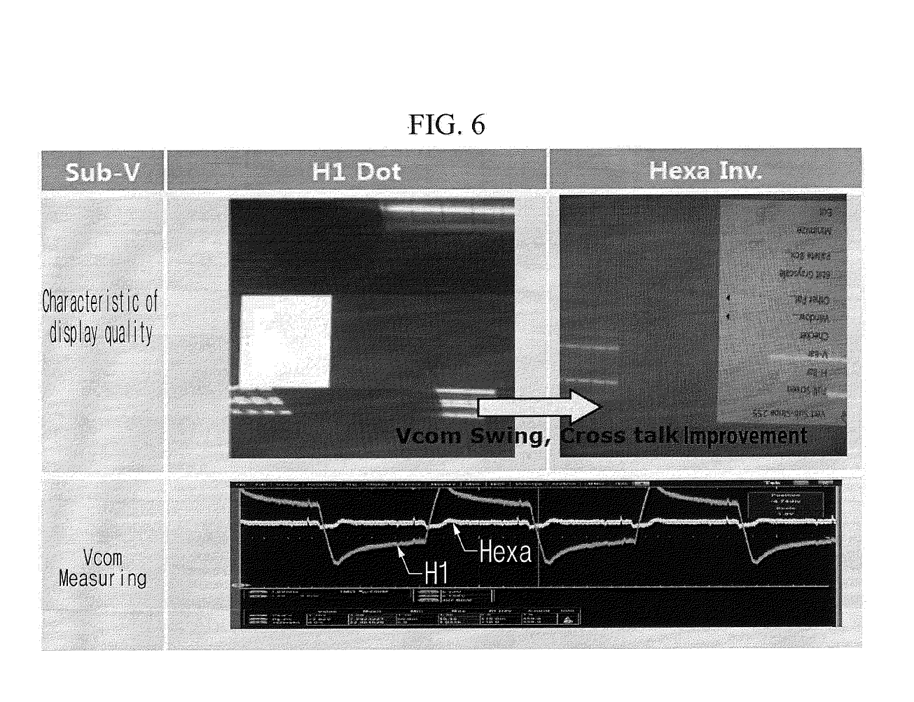

FIGS. 5 and 6 are views showing display quality of a conventional liquid crystal display and an exemplary embodiment of a display device according to the invention when displaying a first image pattern, and FIGS. 7 and 8 are views showing display quality of a conventional liquid crystal display and an exemplary embodiment of a display device according to the invention when displaying a second image pattern.

Referring to FIGS. 5 and 6, an exemplary embodiment of the display device using the inversion driving method, in which six subpixels are inverted as the inversion reference group, is indicated as Hexa Inv. in the right side, and of the conventional liquid crystal display using a conventional dot inversion driving method is indicate as H1 Dot in the left side.

The first image pattern, as shown in FIG. 5, has a pattern, in which subpixels in a same subpixel column displays a same gray level, and pixel columns that displays a maximum gray level and a minimum gray level (e.g., black) are alternately disposed along the subpixel row direction. The first image pattern may be referred to as Sub-V stripe or Sub-V. In the first image pattern or Sub-V stripe, as shown in FIG. 5, a first red pixel column represents the maximum gray and a first green pixel column at the right side of the first red pixel column represents a black, a first blue pixel column at the right side of the first green pixel column represents the maximum gray, a second red pixel column at the right side of the first green pixel column represents the black, the second green pixel column at the right side of the second red pixel column represents the maximum gray, and a second blue pixel column at the right side of the second green pixel represents the black. In the first image pattern, the patterns described above are repeated.

In the conventional dot inversion driving method (H1 Dot), referring to the left side of FIG. 5, a first data line between the first and second subpixel columns is applied with a negative maximum voltage during a first frame, then applied with zero (0) gray voltage (black) during a second frame, and then applied with the negative maximum voltage during a third frame. A second data line between the second and third subpixel columns is applied with the zero (0) gray voltage during the first frame, then applied with a positive maximum voltage during the second frame, and then applied with the zero (0) gray voltage during the third frame. As shown in the graph positioned at the left lower side of FIG. 5, three negative maximum voltages R, G and B, and three zero (0) gray voltages are applied during the first period such that the data voltage is biased to the negative direction, and three positive maximum voltages R, G and B and three 0 gray voltages are applied during the second period such that the data voltage is biased to the positive direction. In the conventional dot inversion driving method, the common voltage Vcom is distorted while being swinging, as shown in FIG. 5.

In an exemplary embodiment of the conversion driving method where six subpixels are inverted as the inversion reference group, referring to the right side Hexa Inv. of FIG. 5, the first data line is applied with the negative maximum voltage during the first frame, the zero (0) gray voltage (black) during the second frame, and then the negative maximum voltage during the third frame. The second data line is applied with the zero (0) gray voltage during the first frame, then the negative maximum voltage during the second frame, and then the zero (0) gray voltage during the third frame. As shown in the graph at the right lower side of FIG. 5, in the exemplary embodiment, three negative maximum voltages R, G and B and three zero (0) gray voltages are In FIG. 5, only a first portion of the display area 300, e.g., the pixel area, in which the negative data voltage is mainly applied, is shown. In an exemplary embodiment, the display area may further include a second portion, e.g., a pixel area (not shown), in which the positive data voltage is mainly applied, disposed adjacent to the first portion such that three positive maximum voltages R′, G′ and B′ and three zero (0) gray voltages corresponding to the graph shown at the right lower of FIG. 5 are also applied during the first, second and third period such that the data voltage of the second portion is biased in the positive direction. In such an embodiment, the pixel area biased to negative and the pixel area biased to positive may balance each other such that the common voltage Vcom is not swinging and thereby not distorted, as shown in the right lower graph of FIG. 5.

In FIG. 5, only a first portion of the display area 300, e.g., the pixel area, in which the negative data voltage is mainly applied, is shown. In an exemplary embodiment, the display area may further include a second portion, e.g., a pixel area (not shown), in which the positive data voltage is mainly applied, disposed adjacent to the first portion such that three positive maximum voltages R′, G′ and B′ and three zero (0) gray voltages corresponding to the graph shown at the right lower of FIG. 5 are also applied during the first, second and third period such that the data voltage of the second portion is biased in the positive direction. In such an embodiment, the pixel area biased to negative and the pixel area biased to positive may balance each other such that the common voltage Vcom is not swinging and thereby not distorted, as shown in the right lower graph of FIG. 5.

FIG. 6 shows display qualities of the conventional dot inversion driving method (H1 Dot) and an exemplary embodiment of the inversion driving method (Hexa Inv.) based on the common voltage Vcom, and graphs showing actually measured common voltages Vcom thereof. As shown in FIG. 6, in the conventional dot inversion driving method, the screen is substantially whitish and crosstalk occurs. In an exemplary embodiment of the inversion driving the invention, the common voltage does not swing, the crosstalk is effectively prevented or substantially reduced, and the whitish phenomenon does not occur.

Hereinafter, the second image pattern will be described with reference to FIGS. 7 and 8.

In FIGS. 7 and 8, an exemplary embodiment of the inversion driving method, in which six subpixels are inverted as the inversion reference group is represented (Hexa Inv.) is shown at the right side thereof, and the conventional dot inversion driving method (H1 Dot) is shown the left side thereof.

The second image pattern in FIGS. 7 and 8 is displayed when subpixels in a same pixel column (e.g., three consecutive subpixel columns) displays a same gray level. In the second image pattern, the pixel column in the maximum gray level and the pixel column in the black are alternately arranged along the pixel row, e.g., a first three consecutive subpixel columns displays maximum gray level, and a second three consecutive subpixels display the black, third three consecutive subpixels display the maximum gray level, and the fourth three consecutive subpixels display the black. The second image pattern may be referred as a V stripe. In the second image pattern (or V stripe), as shown in FIG. 7, a first pixel column (e.g., the first three consecutive subpixel columns of a first red pixel column, a first green pixel column and a first blue pixel column) represents the maximum gray, and a second pixel column (i.e., the second three consecutive subpixel columns of a second red pixel column, a second green pixel column and a second blue pixel column) positioned at the right side of the first pixel column represents the black, and this pattern is repeated in the image.

In the conventional dot inversion (H1 Dot), as shown in the left side of FIG. 7, the first data line is continuously applied with the negative maximum voltage, and the second data line is applied with the positive maximum voltage, and the third data line is applied with the negative maximum voltage, the next three data lines are applied with the zero (0) gray voltage (black). Two data lines of the right side, e.g., the data lines between the fourth and sixth subpixel columns, are continuously applied with the zero (0) gray voltage, the data line at the right side of the sixth subpixel column is alternately applied with the zero (0) gray voltage and the positive maximum voltage.

In the conventional dot inversion driving method, as shown in the graph at the left lower side of FIG. 7, two negative maximum voltages (R, B), one positive maximum voltage (G) and three zero (0) gray voltages are applied in the first period such that the data voltage is biased in the negative direction, and two positive maximum voltages (R, B), one negative maximum voltage (G) and three 0 gray voltages are applied in the second period such that the data voltage is biased in the positive direction. In the conventional dot inversion driving method, the common voltage Vcom is swinging and distorted, as shown in FIG. 7.

An exemplary embodiment of the inversion driving method (Hexa Inv.), in which six subpixels are inverted as the inversion reference group, will be described referring to the right side of FIG. 7. In an exemplary embodiment of the inversion driving method, the first data line and the second data line are continuously applied with the negative maximum voltage, a third data line in the left side thereof is alternately applied with the negative maximum voltage and the zero (0) gray voltage (black). Two data lines of the right side e.g., the data lines between the fourth and sixth subpixel columns, are continuously applied with the zero (0) gray voltage, the data line at the right side of the sixth subpixel column is alternately applied with the zero (0) gray voltage and the positive maximum voltage.

In such an exemplary embodiment, as shown in the right side of FIG. 7, three negative maximum voltages (R, G and B) and three zero (0) gray voltages are applied in the first period and the third period such that the data voltage is biased in the negative direction, and two negative maximum voltages (G, B) and one positive maximum voltage (R) are applied in the second period such that the data voltage is biased in the negative direction. As described above, the pixel structure shown at the right side of FIG. 7 is corresponding to a first portion where the negative data voltage is applied, and the second portion where the positive data voltage is mainly applied is disposed adjacent to the first portion such that the data voltage (R′, G′, and B′ in the right lower graph of FIG. 7) in the second portion is biased in the positive direction. In such an embodiment, the pixel area biased to negative and the pixel area biased to positive may balance each other such that the common voltage Vcom is not swinging and thereby not distorted, as shown in the right lower graph of FIG. 7.

FIG. 8 shows the display quality when the second image pattern is display by the inversion driving methods shown in FIG. 7, and the graph showing measured common voltages Vcom. As shown in FIG. 8, an image with the second image pattern is totally greenish when the second image pattern is display using the conventional dot driving inversion. As shown in FIG. 8, in an exemplary embodiment of the inversion driving method, the swing of the common voltage may not occur, and the image with the second image pattern is not greenish when displayed on a screen.

In an alternative exemplary embodiment, a display device having the non-alternating connection structure, as show in FIG. 4, may be driven using an exemplary embodiment of the inversion driving method, in which six subpixels form the inversion reference group, such that the swing of the common voltage Vcom or distortion of the common voltage Vcom may be effectively prevented.

Hereinafter, common voltages and currents measured when the first image pattern (V-sub stripe), as shown in FIG. 5, is displayed using a conventional dot inversion driving method and an exemplary embodiment of the inversion driving method will be described.

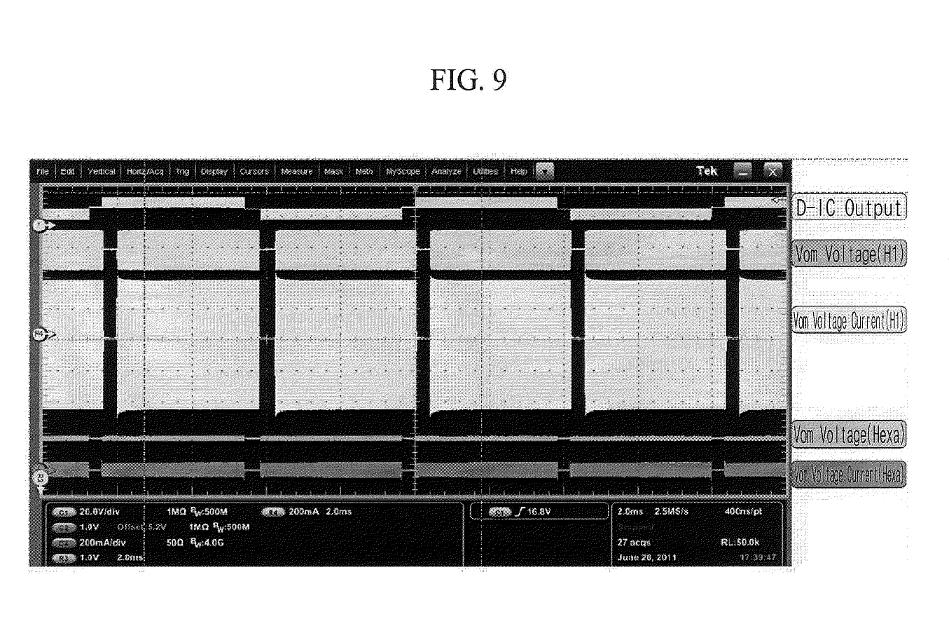

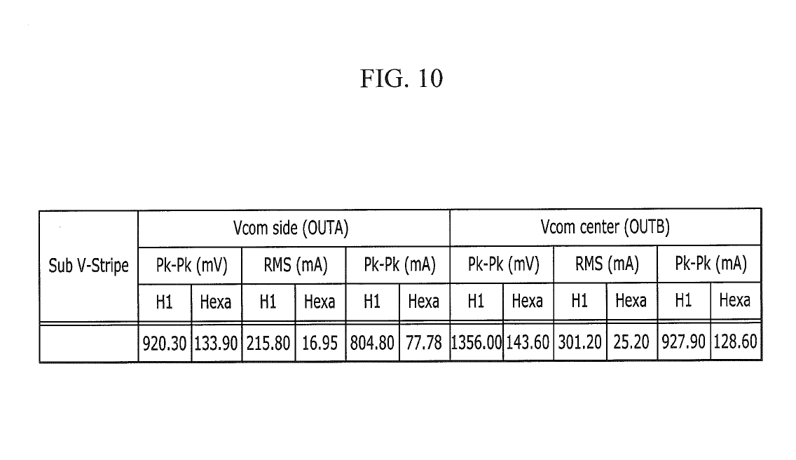

FIGS. 9 and 10 are views showing changes of voltages and current of common voltage when the first image pattern is displayed by a conventional liquid crystal display and an exemplary embodiment of a display device according the invention.

In FIG. 9, voltage and current of a conventional liquid crystal display using the conventional dot inversion driving method are indicated by H1, and voltage and current of an exemplary embodiment of a display device, in which six subpixels are inverted as the inversion reference group, are indicated by Hexa.

As shown in FIG. 9, in the conventional dot inversion driving method, it the voltage and the current of the common voltage Vcom are changed with a relatively large amplitude. In an exemplary embodiment of the invention, amplitude of changes in the voltage and the current of the common voltage Vcom are relatively small. In an exemplary embodiment, the current of the common voltage Vcom corresponding to consumption current is substantially small such that the current consumption or the power consumption is substantially reduced.

FIG. 10 shows a table showing data measured in FIG. 9.

In FIG. 10, a position measuring the common voltage Vcom is divided into two and is shown as a table. “Vcom side” of FIG. 10 indicates the voltage and current values of the common voltage Vcom measured at a side portion of the display area 300 of the display device and a portion outside the display area 300, and “Vcom center” indicates the voltage and current values of the common voltage Vcom measured on a center portion of the display area 300 of the display device. In FIG. 10, “pk-pk” means a difference between peak values of voltages or currents, and RMS means a root mean square value.

As shown in FIG. 10, both in the side and the center portions of the display area, the common voltage changes in an exemplary embodiment is substantially less than the common voltage changes in the conventional display device.

In an exemplary embodiment where the 2mn subpixels are inverted as the inversion reference group, as described above, the common voltage Vcom changes when displaying a specific image pattern using an inversion driving method, which may deteriorate the display quality may be substantially reduced such that the deterioration of the display quality is effectively prevented. In such an embodiment, the inversion reference group includes subpixels more than 2m, where the pixel includes m subpixels, such that a pixel that displays the maximum gray level and a pixel that displays the black are included in the inversion reference group. In such an embodiment, the positive inversion reference group and the negative inversion reference group is balanced when the maximum gray and the black are alternately displayed.

Next, a case of displaying four image patterns will be described with reference to five inversion driving methods through FIGS. 11 and 12.

FIGS. 11 and 12 are tables showing change ratio of data voltages when a display device is driven by various inversion driving methods.

FIGS. 11 and 12 show tables, in which number of instances when the data voltage change is greater than a predetermined degree is included. FIG. 11 shows a table regarding a display device having the alternating connection structure, FIG. 12 shows a table regarding a display device having the non-alternating connection structure, and a pixel of the display device includes three subpixels.

The inversion driving method shown in FIG. 11 and FIG. 12 includes five inversion methods, e.g., H1 represents a dot inversion driving inverted, e.g., a method of inversion with (+)(−)(+)(−)(+)(−), and H3 represents an inversion driving method based on a unit of three subpixels, e.g., a method of inversion with (+)(−)(−)(−)(+)(+) and a method of inversion with (+)(+)(+)(−)(−)(−). An exemplary embodiment of the inversion driving method according to the invention, in which six subpixels corresponding are inverted as a unit is indicated by H6, e.g., a method of inversion with (+)(−)(−)(−)(−)(−)(−) and a method of inversion with (+)(+)(+)(+)(+)(+). In the case of the method of inversion with (+)(−)(−)(−)(−)(−)(−) one data line is applies the data voltage of the positive polarity, a first six data lines subsequent to the one data line apply the data voltage of the negative polarity, and a second six data lines apply the data voltage of the positive polarity. In such an embodiment, the polarity of a data line is changed on a frame-by-frame basis, e.g., every frame. In such an embodiment, the final five data lines of the display area 300 form an inversion reference group along with the first data line.

In FIGS. 11 and 12, data changes for various image patterns are shown, e.g., c the V-stripe (shown in FIG. 7), the Sub-V (shown in FIG. 5), the checker and the sub-checker. The checker image pattern is the image pattern, in which the white and black are displayed, similarly to a chess plate image, are alternately arranged along the pixel row and the pixel column, which three subpixel columns, and the sub-checker is the image pattern in which the maximum gray and the black are alternately arranged along the subpixel column and the subpixel row to form a check pattern.

Referring to FIGS. 11 and 12, a ratio (data toggle ratio) of the methods H1 and H3 in a display device having the alternating connection structure, and a ratio of the methods H1 and H3 in a display device having the non-alternating connection structure are different from each other such that the display quality of a display device using the methods H1 and H3 may not be used for both the display device. In the method H3, the change of the data may not occur when a display device having the alternating connection structure displays the sub-checker pattern such that the change of the common voltage does not occur, and a defect in display quality may not occur. In the method H3, however, a defect in display quality may occur when a display device having the alternating connection structure displays the other three image patterns.

In an exemplary embodiment of the inversion method according to the invention, the methods H6 have substantially the small ratio (data toggle ratio), e.g., 0 or 1, such that the common voltage Vcom is not substantially distorted when displaying the patterns in FIGS. 11 and 12 such that a defect in display quality may not occur. In such an embodiment, as shown in FIGS. 11 and 12, the display quality is not deteriorated in a display device having the alternating connection structure and in a display device having the non-alternating connection structure such that the inversion method methods H6 may be used in a display device having any structure among the alternating connection structure and the non-alternating connection structure.

In an exemplary embodiment, as shown in FIGS. 3 to 12, a unit pixel of a display device may include three subpixels, but not being limited thereto.

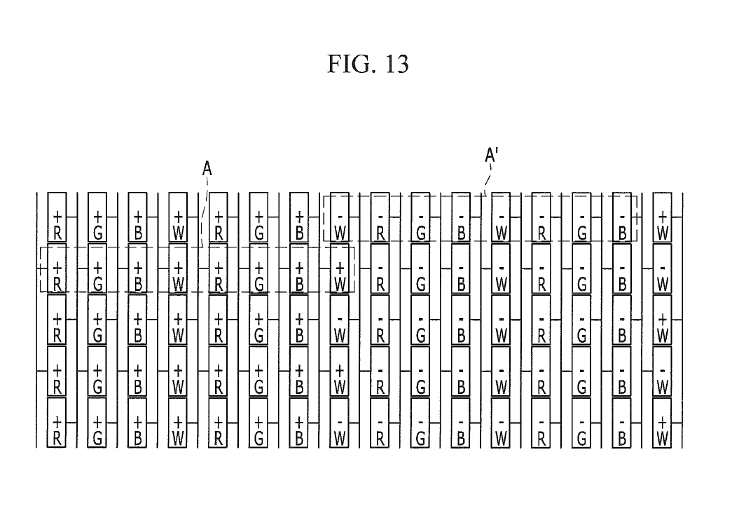

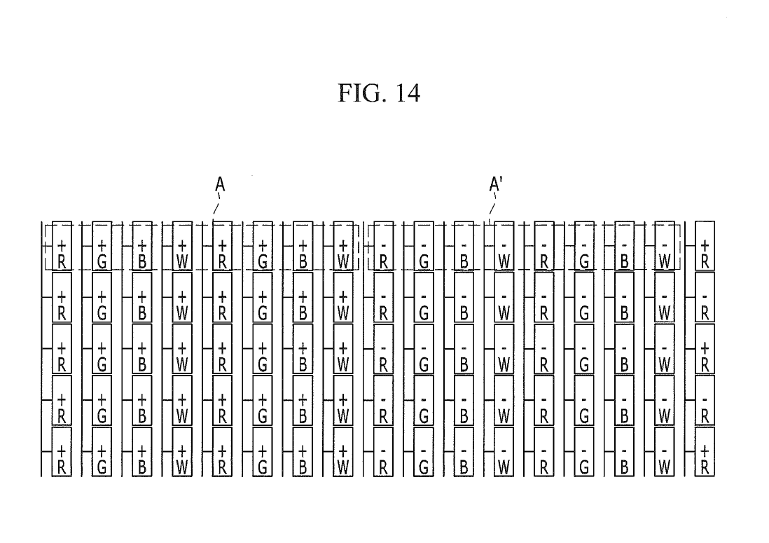

Hereinafter, an exemplary embodiment in which a unit pixel includes four subpixels will be described with reference to FIGS. 13 and 14.

FIGS. 13 and 14 are plan views of subpixels and data lines of a liquid crystal display driven by an alternative exemplary embodiment of an inversion driving method of a liquid crystal display according to the invention.

In FIGS. 13 and 14, the number of subpixels included in a unit pixel is four, e.g., m=4, such that eight (2mn=8 when n=1) subpixels are inversely driven as the inversion reference group. In such an embodiment, as shown in FIGS. 13 and 14, the inversion driving is performed in a unit of a horizontal period 1H.

In an exemplary embodiment, the liquid crystal display shown in FIG. 13 has the alternating connection structure in which each data line connects neighboring subpixels with the zigzag shape.

In FIG. 13, A and A′ show inversion reference groups including eight subpixel electrodes as the basic unit of the polarity inversion. In FIG. 13, the A subpixel group represents a subpixel applied with the positive data voltage in the current frame, and the A′ subpixel group represents a subpixel applied with the negative data voltage in the current frame. The data line applies the data voltage with the same polarity during a unit frame such that the polarity of the data voltage according to FIG. 13 is maintained during one frame, the positive data voltage is changed to the negative data voltage in a next frame, and then the negative data voltage is changed to the positive data voltage in the next frame.

In an exemplary embodiment of a display device having the alternating connection structure of FIG. 13, a pixel in the subpixel group A and a pixel in the subpixel group A′ overlap each other in the subpixel row direction. In such an embodiment, as shown in FIG. 13, the leftmost side white (W) subpixel of the subpixel group A′ and the rightmost side white (W) subpixel of the subpixel group A are overlapping each other in the subpixel row direction.

In FIG. 13, the seven subpixel electrodes of the first pixel row of FIG. 13 from the leftmost side are applied with the positive data voltage, and the last subpixel is applied with the positive data voltage, such that the inversion reference group including eight subpixel electrodes is defined the eight subpixels.

In an alternative exemplary embodiment, as shown in FIG. 14, the inversion driving method based on an inversion reference group having eight subpixels may be used in a display device having non-alternating connection structure.

In a display device having the non-alternating connection structure, the subpixel group A and the subpixel group A′ do not overlap, and are separated with respect to the data line.

In an exemplary embodiment, as shown in FIGS. 13 and 14, eight subpixels from the leftmost side of the display area 300 may form the inversion reference group. In an alternative exemplary embodiment, data lines connected to less than eight subpixels from the leftmost side of the display area 300 may be applied with a same polarity, and next data lines may be applied with the opposite polarity. In such an embodiment, the inversion reference group may be defined by the less than eight subpixels and subpixels having the same polarity and in the rightmost side of the display area 300.

The inversion reference group may be described with reference to the data line. In a display device having the non-alternating connection structure, the number of data lines is the same as the number of subpixels such that the 2mn data lines are inverted as the inversion reference group. In a display device having the alternating connection structure, an additional data line may be further provided such that the number of data lines is not divided into the number (2mn) of the inversion reference group.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display area including a plurality of pixels, wherein each of the pixels includes m subpixels; and
a plurality of data lines connected to the pixels,
wherein 2n pixels of the pixels define an inversion reference group,
wherein 2mn subpixels in the inversion reference group are applied with data voltages of a same polarity, and
wherein each of n and m is a natural number.

2. The display device of claim 1, wherein a polarity of data voltages applied to the inversion reference group in a current frame and a polarity of data voltages applied to the inversion reference group in a next frame are opposite to each other.

3. The display device of claim 2, wherein m is 3 or 4.

4. The display device of claim 3, wherein the inversion reference group is defined by at least one subpixel initially positioned in a pixel row of the display area and at least one subpixel lastly positioned in the pixel row.

5. The display device of claim 3, wherein the data lines and the subpixels in the display area have an alternating connection structure.

6. The display device of claim 3, wherein the data lines and the subpixels in the display area have a non-alternating connection structure.

7. A method of driving a display device, the method comprising:
applying a data voltage having a first polarity to a plurality of data lines of the display device connected to 2mn subpixels of a plurality of subpixels in a display area of the display device; and
applying a data voltage having a second polarity, which is opposite to the first polarity, to the data lines connected to the 2mn subpixels,
wherein each of n and m is a natural number.

8. The method of claim 7, wherein the 2mn subpixels define an inversion reference group.

9. The method of claim 8, wherein m is 3 or 4.

10. The method of claim 9, wherein the inversion reference group is defined by at least one subpixel initially positioned in a pixel row of the display area and at least one subpixel lastly positioned in the pixel row.

11. The method of claim 9, wherein the data lines and the subpixels in the display area have an alternating connection structure.

12. The method of claim 9, wherein the data lines and the subpixels in the display area have a non-alternating connection structure.
